(19) United States
(12) Patent Application Publication
(10) Pub. No.: US 2025/0389887 A1
(43) Pub. Date: Dec. 25, 2025

(54) OPTICAL FIBER MODE STRIPPER, MANUFACTURING METHOD FOR OPTICAL FIBER MODE STRIPPER, AND LASER

(71) Applicant: WuHan Raycus Fiber Laser Technologies CO., LTD, Wuhan, Hubei (CN)

(72) Inventors: Jinxing LIU, Wuhan, Hubei (CN); Dapeng YAN, Wuhan, Hubei (CN); Juekui LUO, Wuhan, Hubei (CN); Lilei TANG, Wuhan, Hubei (CN); Xiang SHEN, Wuhan, Hubei (CN); Yifan MAI, Wuhan, Hubei (CN)

(73) Assignee: WuHan Raycus Fiber Laser Technologies CO., LTD, Wuhan, Hubei (CN)

(21) Appl. No.: 18/992,996

(22) PCT Filed: Oct. 8, 2023
(86) PCT No.: PCT/CN2023/123352

§ 371 Date: Jan. 10, 2025

(30) Foreign Application Priority Data
Oct. 10, 2022 (CN) 202211231633.4

(51) Int. Cl. G02B 6/02; H01S 3/08018

(52) U.S. Cl. CPC G02B 6/0238; G02B 6/02357; H01S 3/08018

(57) ABSTRACT

An optical fiber mode stripper, a manufacturing method for an optical fiber mode stripper, and a laser are provided. The optical fiber mode stripper includes an optical fiber and fillers. The optical fiber is provided with a waveguide destruction region extending along a length direction of the optical fiber. A portion of the optical fiber in the waveguide destruction region includes a core and a cladding layer. The cladding layer is provided with recessed structures disposed at intervals along the length direction of the optical fiber and/or disposed at intervals circumferentially around the cladding layer. The fillers are filled in the recessed structures. The filler has a refractive index greater than a refractive index of the cladding layer.

This application claims priority to Chinese Patent Application No. 202211231633.4 filed with the Chinese Patent Office on Oct. 10, 2022, the entire contents of which are incorporated herein by reference.

### TECHNICAL FIELD

The present application belongs to the technical field of lasers, and more particularly, relates to an optical fiber mode stripper, a manufacturing method for an optical fiber mode stripper, and a laser.

### BACKGROUND

In the prior art, in a manufacturing process for a mode stripper, a cladding layer of an optical fiber is marked by using a carbon dioxide marking machine, so that a waveguide structure inside the cladding layer of the optical fiber is damaged, and laser energy in the cladding layer is scattered out of the cladding layer of the optical fiber due to damage of the waveguide structure when flowing through a marked region. When the marking region is prepared by the carbon dioxide marking machine, a thermal effect is generated to act on the optical fiber, which causes the optical fiber to warp, and thus affects the beam quality. The powder generated during the marking process melts in the marking region, which affects the absorption rates of both the laser light and the heat dissipation light, and thus causes the optical fiber to generate heat. So, the optical fiber is damaged, and the optical fiber has a short service life. In addition, after the cladding layer of the optical fiber of the mode stripper is damaged, the structural strength of the optical fiber is too low. In order to take into account the strength of the mode stripper, the size of the marking region is limited, and the mode stripping efficiency of the mode stripper is low.

### SUMMARY

The problems of a low structure strength and a short service life of an optical fiber in an existing mode stripper are solved.

In a first aspect, embodiments of the present application provide an optical fiber mode stripper including:
an optical fiber provided with a waveguide destruction region, in which the waveguide destruction region extends along a length direction of the optical fiber, a portion of the optical fiber which is in the waveguide destruction region includes a core and a cladding layer, the cladding layer wraps around the core, a plurality of recessed structures are disposed in the cladding layer, the plurality of recessed structures are disposed at intervals along the length direction of the optical fiber and/or the plurality of recessed structures disposed at intervals circumferentially around the cladding layer, and depths of the plurality of recessed structures are less than a thickness of the cladding layer; and
fillers filled in the recessed structures, in which the fillers each have a refractive index greater than a refractive index of the cladding layer.

Optionally, depths of the plurality of recessed structures are the same;
or depths of the plurality of recessed structures are increased gradually, decreased gradually, or increased gradually first and then decreased gradually along the length direction of the optical fiber, and the depths of ones of the plurality of recessed structures located on a same circumference are the same;
in which the depths of the plurality of recessed structures are each a maximum distance between a plane in which a side of the cladding layer facing away from the core is located and a side wall of a corresponding one of the plurality of recessed structures.

Optionally, each of the depths of the plurality of recessed structures is less than one-tenth of a diameter of the cladding layer, in which a maximum distance between a plane in which a side of the cladding layer facing away from the core and a side wall of each of the plurality of recessed structures is the depth of the recessed structure.

Optionally, a ratio of an area of each of ones of the plurality of recessed structures on a same section to an area of the cladding layer is less than one half in a direction perpendicular to the length direction of the optical fiber.

Optionally, each of depths of the plurality of recessed structures is less than 20 μm, in which a maximum distance between a plane in which a side of the cladding layer facing away from the core and a side wall of each of the plurality of recessed structures is the depth of the recessed structure.

Optionally, the fillers are low-melting-point glass.

In a second aspect, embodiments of the present application further provide a manufacturing method for any one of optical fiber mode strippers mentioned above, the method including:
corroding the optical fiber by an acid corrosion process to form the plurality of recessed structures;
placing the optical fiber in a filler solution, and filling the fillers in the recessed structures; and
removing fillers outside the recessed structures through the acid corrosion process.

Optionally, the step of corroding the optical fiber by an acid corrosion process to form the plurality of recessed structures includes:
step 1, removing the coating layer of the optical fiber which is corresponding to the waveguide destruction region at intervals, and forming, in the coating layer, a plurality of grooves exposing the cladding layer at a position where the plurality of grooves are located, in which the plurality of grooves are arranged at intervals along the length direction of the optical fiber and the plurality of grooves are arranged at intervals circumferentially around the coating layer; and
step 2, placing the optical fiber processed in step 1 in an acid corrosion solution at a certain concentration, and corroding the optical fiber for a period of time to form the plurality of recessed structures at portions of the cladding layer which are opposite to the plurality of grooves.

Optionally, the step of placing the optical fiber in a filler solution and filling the fillers in the recessed structures includes:
step 3, placing the optical fiber processed in step 2 in a molten filler solution to wholly remove the coating layer of the optical fiber which corresponds to the waveguide destruction region, and filling the fillers in the recessed structures.

In a third aspect, embodiments of the present application provide a laser including any one of the optical fiber mode strippers mentioned above.

### BENEFICIAL EFFECT

According to the optical fiber mode stripper, the manufacturing method for the optical fiber mode stripper and the laser provided by the embodiments of the present application, recessed structures in a cladding layer of an optical fiber are filled with fillers, and the refractive index of the filler is larger than the refractive index of the cladding layer. As the laser transmitted in the waveguide tends to transmit in a high refractive region, the laser in the cladding layer refracts out of the optical fiber through the fillers, so that the effect of stripping the cladding light is achieved. The fillers may match the expansion coefficient of the optical fiber, so that the linear expansion coefficient and the shrinkage rate of the optical fiber are reduced. In this way, the internal stressing force of the optical fiber is eliminated, and the optical fiber is prevented from cracking, thereby overcoming the problems of the low structure strength and the short service life of the optical fiber of the existing mode stripper, and thus improving the structure strength and the service life of the optical fiber.

### BRIEF DESCRIPTION OF THE DRAWINGS

In order that the technical solution in the embodiments of the present application may be explained more clearly, a brief description will be given below for the drawings required for use in the description of the embodiments. Obviously, the drawings in the following description are merely some of the embodiments of the present application, and other drawings can be made from these drawings without involving any inventive effort to those skilled in the art.

For a more complete understanding of the present application and its advantages, reference will now be made to the accompanying drawings. In the following description, like reference numerals refer to like parts.

FIG. 1 is a schematic axial-direction sectional view showing same depths of recessed structures in an optical fiber of a mode stripper according to an embodiment of the present application.

FIG. 2 is an axial-direction sectional view of gradually increasing depths of recessed structures in an optical fiber of a mode stripper according to an embodiment of the present application.

FIG. 3 is a schematic sectional view of an optical fiber of a mode stripper perpendicular to the axial direction according to an embodiment of the present application.

FIG. 4 is an axial-direction sectional view of an optical fiber obtained by a first step during a manufacture process of an optical fiber mode stripper according to an embodiment of the present application.

FIG. 5 is an axial-direction sectional view of an optical fiber obtained by a second step during a manufacture process of an optical fiber mode stripper according to an embodiment of the present application.

FIG. 6 is a flow chart showing a manufacturing method for an optical fiber mode stripper according to an embodiment of the present application.

### DETAILED DESCRIPTION

The technical solution in the embodiments of the present application will be clearly and completely described with reference to the accompanying drawings. It will be apparent that the described embodiments are only a part of the examples of the present application, and not all examples. Based on the embodiments in the present application, all other embodiments obtained by a person skilled in the art without involving any inventive effort are within the scope of the present application.

An embodiment of the present application provides an optical fiber mode stripper to solve the problems of a low structure strength and a short service life of an optical fiber of an existing mode stripper. The following description will be made in conjunction with the accompanying drawings.

The optical fiber mode stripper is applied between the laser and an outputting head for the laser, so as to strip residual pumping light of the laser to ensure that only the laser light is output from the laser, so the laser transmission quality of the optical fiber laser is improved.

In order to more clearly illustrate the structure of the optical fiber mode stripper, the optical fiber mode stripper will be described below in connection with the accompanying drawings.

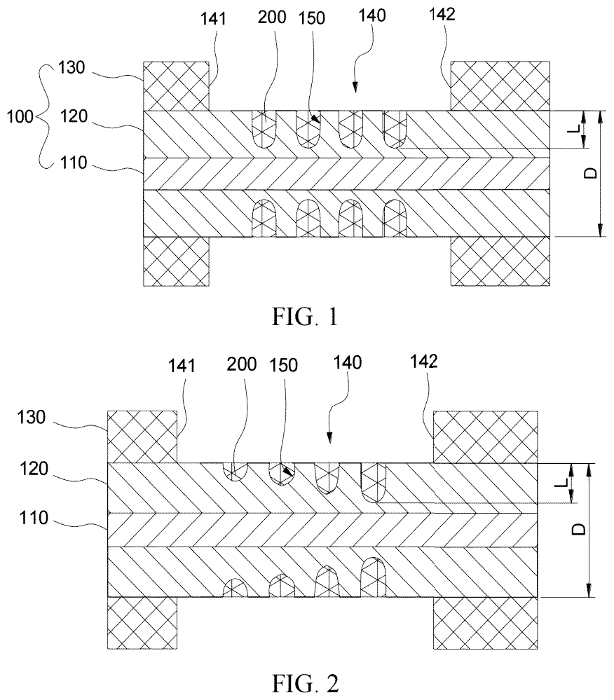

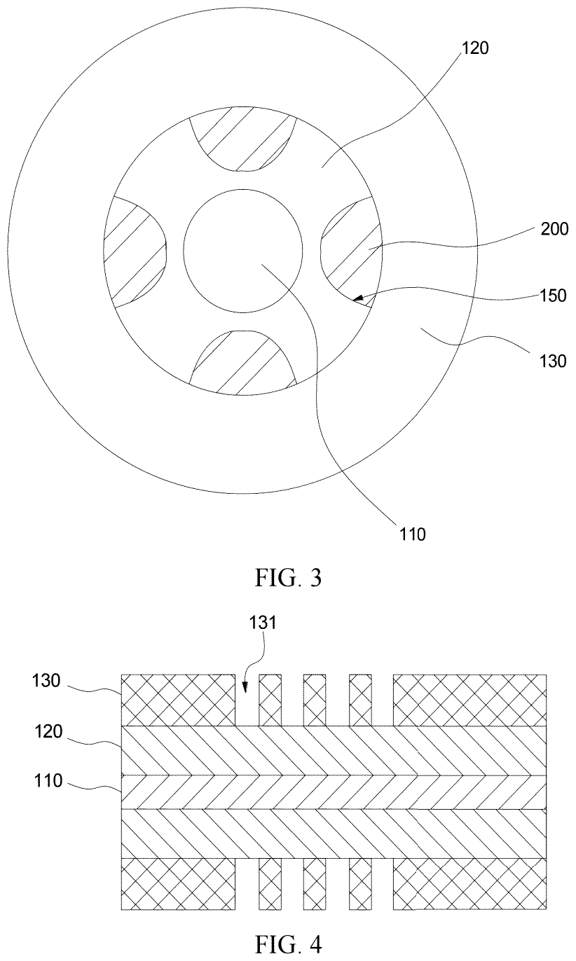

Referring to FIGS. 1 and 3, FIG. 1 is a schematic axial-direction sectional view showing the same depths of recessed structures in an optical fiber of a mode stripper according to an embodiment of the present application, and FIG. 3 is a schematic sectional view showing an optical fiber of the mode stripper perpendicular to the axial direction according to an embodiment of the present application.

An embodiment of the present application provides an optical fiber mode stripper including an optical fiber 100 and fillers 200. The optical fiber 100 is a double-clad optical fiber. The double-clad optical fiber has a core 110, a cladding layer 120, and a coating layer 130. The cladding layer 120 wraps around the core 110. The coating layer 130 wraps around the cladding layer 120. A segment of the optical fiber extending along an axial direction of the optical fiber 100 and stripping off the coating layer 130 is a waveguide destruction region 140. The waveguide destruction region 140 extends a distance along a length direction of the optical fiber 100. The segment of the optical fiber in the waveguide destruction region 140 includes the core 110 and the cladding layer 120. The cladding layer 120 wraps around the core 110. A surface of the cladding layer 120 is corroded via an acid corrosion process to form a plurality of recessed structures 150. The plurality of recessed structures 150 are spaced apart in the surface of the cladding layer 120. The plurality of recessed structures 150 are spaced apart along the length direction of the optical fiber 100 and/or the plurality of recessed structures 150 are spaced apart circumferentially around the cladding layer 120. The position and the quantity of the recessed structures 150 are set according to the required stripping efficiency. The fillers 200 are filled in the recessed structures 150. A refraction index of the filler 200 is greater than a refraction index of the cladding layer 120. The laser light transmitted in the waveguide destruction region 140 tends to be transmitted in the high refraction region, and the refraction index of the filler 200 is greater than the refraction index of the cladding layer 120. The laser light in the cladding layer 120 is refracted out of the optical fiber 100 through the fillers 200 to strip the cladding light. The filler 200 is attached to an inner wall of the recessed structure 150 to match the expansion coefficient of the optical fiber 100, so the linear expansion coefficient and the shrinkage rate of the optical fiber 100 may be reduced, and the stressing force insides the optical fiber 100 may be eliminated. After the fillers 200 are filled in the recessed structures 150, outer diameters of the optical fiber 100 in the waveguide destruction region 140 are the same, and there is no weak position, thereby improving the structural strength of the optical fiber 100.

It will be appreciated that since the fillers 200 fill in the recessed structures 150 so that the outer diameters of the optical fiber 100 in the waveguide destruction region 140 are the same, the depths of the recessed structures 150 may be deepened when the recessed structures 150 are processed regardless of the influence of the structural strength. A maximum distance between a plane where a side of the cladding layer 120 which is away from of the core 110 is located and a side wall of the recessed structure 150 is the depth of the recessed structure 150. The deeper the depth of the recessed structure 150, the better the mold stripping effect of the mode stripper. By filling the fillers 200 in the recessed structures 150, not only the structural strength of the optical fiber may be increased, but also the mold stripping effect of the mode stripper may be improved.

The recessed structure 150 may be an annular groove provided circumferentially around the surface of the cladding layer 120. The recessed structure 150 has a “U”-shaped section along the axial section of the optical fiber 100. Multiple recessed structures 150 are provided at intervals along the length direction of the optical fiber 100. As a variant, the recessed structure 150 may be a strip-shaped groove extending along the length direction of the optical fiber 100; and a plurality of recessed structures 150 are provided circumferentially around the cladding layer 120 at intervals in a section perpendicular to the axial direction of the optical fiber 100, and the recessed structures 150 each have a “U”-shaped section. As another variation, as shown in FIG. 3, the above-mentioned recessed structure 150 is a depression, and the recessed structure 150 has a “U”-shaped section along the axial section of the optical fiber 100 and along a section of the optical fiber 100 perpendicular to the axial section of the optical fiber 100. The recessed structures 150 are arranged at intervals around the circumference of the cladding layer 120, and are arranged at intervals along the length direction of the cladding layer 120. The number and the position of the recessed structures 150 located on different sections perpendicular to the axial direction of the optical fiber 100 may be the same. For example, four recessed structures 150 are provided on each section, and the four recessed structures 150 are all located on the quadrant of the circle. As a variation, the number and the position of the recessed structures 150 located on different sections perpendicular to the axial direction of the optical fiber 100 may be different. The shape, the number and the position of the recessed structure 150 may be designed according to a specific desired stripping effect. The embodiments of the present application are not specifically limited.

In some embodiments, the filler 200 is low-melting-point glass.

It will be appreciated that by filling the low-melting-point glass in the recessed structures 150, when the laser light transmitted in the cladding layer 120 flows through the waveguide destruction region 140, the laser light is refracted out because the refractive index of the low-melting-point glass is higher than that of the cladding layer 120, thereby achieving the effect of stripping the laser light in the cladding layer 120. The low-melting-point glass has a good insulating property, and filled portions of the cladding layer 120 has a good insulating property and an arc resistance. So, the low-melting-point glass matches the expansion coefficient of the optical fiber 100, thereby reducing the linear expansion coefficient and the shrinkage ratio of the cured product, and thus eliminating the internal stressing force of the cured product. The low-melting-point glass also has corrosion resistance and does not chemically react with most of the acid and the alkali. Therefore, the surface of the optical fiber 100 has a strong corrosion resistance. In addition, the low-melting-point glass also has a strong fire resistance effect, thereby improving the fire resistance property of the optical fiber 100.

In some embodiments, as shown in FIG. 1, the depths of the plurality of recessed structures 150 in the waveguide destruction region 140 are the same, and the filling amount of the low-melting-point glass filled in recessed structures 150 is the same, thereby facilitating processing operations.

As a variation, referring to FIG. 2, FIG. 2 is an axial-direction sectional view of gradually increasing depths of recessed structures in an optical fiber of the mode stripper according to an embodiment of the present application. The waveguide destruction region 140 has a first end 141 and a second end 142. In an extension direction from the first end 141 to the second end 142, the depths of the plurality of recessed structures 150 increases gradually, or decreases gradually, or decreases gradually firstly and then decreases gradually, and the depths of the plurality of recessed structures 150 located on the same circumference are the same. Correspondingly, in an extension direction from the first end 141 to the second end 142, the filling amount of the fillers 200 filled in the recessed structures 150 increases gradually, or decreases gradually, or increases gradually first and then decreases gradually. By controlling the depths of the recessed structures 150 in the waveguide destruction region 140 to be different from each other, and the filling is performed by using low-melting-point glass in an unequal amount manner, the laser light in the cladding layer 120 is relatively uniformly refracted out when flowing through the waveguide destruction region 140, thereby improving the thin film effect.

In some embodiments, referring to FIGS. 1 and 2, the depth L of the recessed structure 150 is less than one tenth of a diameter D of the cladding layer 120.

It will be appreciated that the depth L of the recessed structure 150 in the embodiments of the present application may be one tenth, one fifteenth, one twentieth, or the like of the diameter D of the cladding layer 120. When the fillers 200 are cured in the recessed structures 150, a large stressing force is generated. The stressing force is excessively large, thus the entire structure of the optical fiber 100 is hard and fragile, and the structural strength thereof is reduced. Considering the optical performance and the structural performance of the mode stripper, the depths of the recessed structures 150 are each designed to be less than one tenth of the diameter D of the cladding layer 120.

In some embodiments, a ratio of areas of the recessed structures 150 in the same section to an area of the cladding layer 120 is less than one half in the direction perpendicular to the length of the optical fiber 100.

It will be appreciated that the recessed structure 150 in this embodiment of the present application may have an area of one-half, one-third, one-fourth, one-fifth or the like of an annular area of the cladding layer 120. In this way, it may ensure the optical performance of the mode stripper while reducing the curing effect of the fillers 200, so as to ensure that the structural strength of the optical fiber 100 is reliable.

In some embodiments, as shown in FIG. 3, the depth of the recessed structure 150 is less than 20 μm. It will be appreciated that the depth of the recessed structure 150 may be 20 μm, 19 μm, 18 μm, 17 μm, 16 μm, 15 μm, 14 μm, 13 μm, 12 μm, etc., or other values below 20 μm that are not listed.

Taking the mode stripper with a total length of 10 cm as an example, a distance between the adjacent recessed structures 150 is 0.02 μm along the length direction of the optical fiber 100. If the fillers 200 are not provided, the maximum depths of the recessed structures 150 ranges from 10 μm to 12 μm, and the stripping efficiency of the mode stripper is 97%. If the fillers 200 are provided, the maximum depths of the recessed structures 150 may be set to 20 μm, and the stripping efficiency of the mode stripper is 99%. Therefore, the stripping efficiency is improved, and the structure strength of the optical fiber of the mode stripper is increased, thereby improving the service life of the mode stripper.

Referring to FIG. 6, FIG. 6 is a flow chart of a manufacturing method for an optical fiber mode stripper according to an embodiment of the present application.

An embodiment of the present application further provides a manufacturing method for an optical fiber mode stripper, for manufacturing any of the optical fiber mode strippers mentioned above, including the steps of:
at step S1, corroding the optical fiber 100 by an acid corrosion process to form the recessed structures 150;
at step S2, placing the optical fiber in a filler solution, and filling fillers 200 in the recessed structures 150; and
at step S3, removing fillers outside the recessed structures 150 by the acid corrosion process.

It will be appreciated that the cladding layer 120 of the optical fiber 100 is corroded by the acid corrosion chemical process to form the recessed structures 150 in the present embodiments. Compared with the prior art in which the recessed structures obtained by marking the cladding layer of the optical fiber via the carbon dioxide marking machine, in the present application, molten powders are not deposited on the surface of the recessed structures 150, so that absorption of the laser light and the scattered light by the cladding layer 120 is reduced, the thermal effect is avoided and the occurrence of warpage of the optical fiber is avoided, thereby prolonging the service life of the optical fiber.

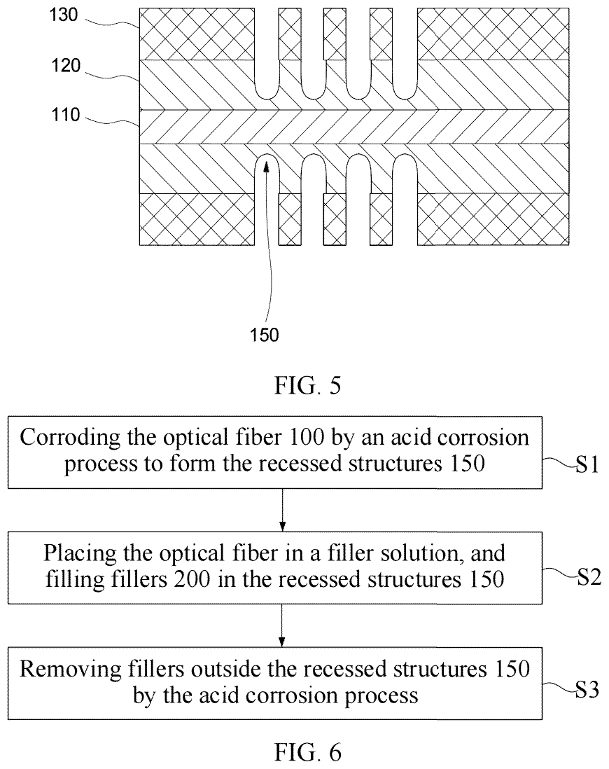

Referring to FIG. 1, FIG. 4 and FIG. 5, FIG. 4 is an axial-direction sectional view of an optical fiber obtained by a first step during a manufacturing process of an optical fiber mode stripper according to an embodiment of the present application, and FIG. 5 is an axial-direction sectional view of an optical fiber obtained by a second step during the manufacturing process of an optical fiber mode stripper according to an embodiment of the present application.

On the basis of the above embodiments, the step of corroding the optical fiber by an acid corrosion process to form recessed structures includes the steps of:
at step 1, removing the coating layer 130 of the optical fiber 100 which is corresponding to the waveguide destruction region 140 at intervals; and forming a plurality of grooves 131, in the coating layer 130, exposing the cladding layer 120 at the position where the grooves 131 are located; in which the plurality of grooves 131 are arranged at intervals along the length direction of the optical fiber and/or the plurality of grooves 131 are arranged at intervals around the circumferential direction of the coating layer 130; and
at step 2, as shown in FIG. 4, placing the processed in step 1 in an acid corrosion solution at a certain concentration, and corroding the optical fiber for a period of time to form the recessed structures at portions of the cladding layer which are opposite to the grooves.

On the basis of the above-described embodiments, the step of placing the optical fiber 100 in a filler solution, and filling the fillers 200 in the recessed structures 150 includes the step of:
at step 3, as shown in FIG. 5, placing the optical fiber 100 processed in step 2 in a molten filler solution to remove wholly the coating layer 130 of the optical fiber 100 which corresponds to the waveguide destruction region 140, and filling the fillers 200 in the recessed structures 150.

In the above-described step 1, a femtosecond laser or a carbon dioxide laser is used to focus on the surface of the coating layer 130 of the optical fiber 100. The coating layer 130 is partially removed at intervals without damaging the cladding layer 120, and a plurality of grooves 131 are formed in the coating layer 130, as shown in FIG. 4. The plurality of grooves 131 are provided at intervals along the length direction of the optical fiber 100, and are provided at intervals around the circumference of the optical fiber 100. A ratio of a width of the groove 131 to a width of the coating layer 130 between adjacent grooves 131 is 1:1. In the axial section of the optical fiber 100, for the grooves 131 on the same section, a distance between a side wall of the groove 131 and the other side wall of the groove 131 is the width of the groove 131, and a distance between the side wall of the groove 131 and a side wall of the adjacent groove 131 is the width of the coating layer.

In the above step 2, the optical fiber segment processed in the step 1 is immersed in a hydrofluoric acid solution having a certain concentration, a certain temperature and a certain humidity, and eroded for a certain time to form recessed structures 150, as shown in FIG. 5; and then washed by using clear water to remove residual hydrofluoric acid solution thereon. As can be appreciated, since an organic resin material in the coating layer 130 is generally corroded by hydrofluoric acid, the coating layer 130 is not damaged by hydrofluoric acid for a short time. And, the material of the cladding layer 120 is a silicon dioxide material, which is corroded by hydrofluoric acid to be thinned to form the recessed structures 150.

When the depths of the recessed structures 150 formed by corroding the cladding layer 120 are the same, taking the recessed structures each having a depth of 14 μm as an example, in a hydrofluoric acid solution at a concentration of 20%, the optical fiber is corroded for 13 minutes; in a hydrofluoric acid solution at a concentration of 30%, the optical fiber is corroded for 6.5 minutes; and in a hydrofluoric acid solution at a concentration of 40%, the optical fiber is corroded for 2.5 minutes. The hydrofluoric acid and the corrosion time may be adjusted according to the actual required corrosion effect. As a variant, when the depths of the recessed structures 150 formed by corroding the cladding layer 120 are different, for example, the depths of the recessed structures 150 are gradually increased and then gradually decreased in the length direction of the optical fiber 100, the recessed structures 150 are segmentally corroded. When a hydrofluoric acid solution with different concentrations is used, the deeper the depth, the higher the hydrofluoric acid concentration required. The hydrofluoric acid solution with the same concentration may be used, whereas the deeper the depth required, the longer the deep corrosion time required.

At the above step 3, the low-melting-point glass powder is heated and melted, and the optical fiber segment processed in step 2 is immersed in the low-melting-point glass solution. Since the melting point and the boiling point of the coating layer 130 are lower than those of the low-melting-point glass solution, the low-melting-point glass solution is in contact with the coating layer 130, and the coating layer 130 is removed by combing the functions of the high-temperature combustion and the volatilization. Due to the capillary function, the liquid low-melting-point glass is automatically filled into the recessed structures 150, as shown in FIG. 1. The optical fiber 100 is removed from the low-melting-point glass solution, and is cooled and dissipated. The low-melting-point glass solution rapidly coagulates in the surface of the cladding layer 120, and the optical fiber coagulating with the low-melting-point glass is immersed in a hydrofluoric acid solution at a concentration of 10%, so as to remove the low-melting-point glass from the surface of the cladding layer 120 which does not have the non-recessed structures 150.

In the above-mentioned embodiments, the description of each embodiment has its own emphasis, and parts not described in detail in a certain embodiment may be referred to the related description of other embodiments.

In the description of this application, the terms “first” and “second” are used for descriptive purposes only and are not to be construed as indicating or implying relative importance or implying the number of indicated technical features. Therefore, features defined as “first” or “second” may explicitly or implicitly include one or more features.

The above detailed description of an optical fiber mode stripper, a manufacturing method for an optical fiber mode stripper, and a laser is made according to an embodiment of the present application. Specific examples are used to explain the principles and embodiments of the present application, and the description of the above examples is merely provided to help understand the method of the present application and the core idea thereof; At the same time, variations will occur to those skilled in the art in both the detailed description and the scope of application in accordance with the teachings of the present application. In summary, the present description should not be construed as limiting the application.

1. An optical fiber mode stripper comprising:
an optical fiber provided with a waveguide destruction region, wherein the waveguide destruction region extends along a length direction of the optical fiber, a portion of the optical fiber which is in the waveguide destruction region comprises a core and a cladding layer, the cladding layer wraps around the core, a plurality of recessed structures are disposed in the cladding layer, the plurality of recessed structures are disposed at intervals along the length direction of the optical fiber and/or the plurality of recessed structures disposed at intervals circumferentially around the cladding layer, and depths of the plurality of recessed structures are less than a thickness of the cladding layer; and
fillers filled in the recessed structures, wherein the fillers each have a refractive index greater than a refractive index of the cladding layer.

2. The optical fiber mode stripper according to claim 1, wherein depths of the plurality of recessed structures are the same.

3. The optical fiber mode stripper according to claim 1, wherein depths of the plurality of recessed structures are increased gradually along the length direction of the optical fiber, and the depths of ones of the plurality of recessed structures located on a same circumference are the same, wherein the depths of the plurality of recessed structures are each a maximum distance between a plane in which a side of the cladding layer facing away from the core is located and a side wall of a corresponding one of the plurality of recessed structures.

4. The optical fiber mode stripper according to claim 1,
the plurality of recessed structures are decreased along the length direction of the optical fiber, and the depths of ones of the plurality of recessed structures located on a same circumference are the same;
wherein the depths of the plurality of recessed structures are each a maximum distance between a plane in which a side of the cladding layer facing away from the core is located and a side wall of a corresponding one of the plurality of recessed structures.

5. The optical fiber mode stripper according to claim 1,
the plurality of recessed structures are increased gradually first and then decreased gradually along the length direction of the optical fiber, and the depths of ones of the plurality of recessed structures located on a same circumference are the same;
wherein the depths of the plurality of recessed structures are each a maximum distance between a plane in which a side of the cladding layer facing away from the core is located and a side wall of a corresponding one of the plurality of recessed structures.

6. The optical fiber mode stripper according to claim 1, wherein each of the depths of the plurality of recessed structures is less than one-tenth of a diameter of the cladding layer, wherein a maximum distance between a plane in which a side of the cladding layer facing away from the core and a side wall of each of the plurality of recessed structures is the depth of the recessed structure.

7. The optical fiber mode stripper according to claim 1, wherein a ratio of an area of each of ones of the plurality of recessed structures on a same section to an area of the cladding layer is less than one half in a direction perpendicular to the length direction of the optical fiber.

8. The optical fiber mode stripper according to claim 1, wherein each of depths of the plurality of recessed structures is less than 20 μm, wherein a maximum distance between a plane in which a side of the cladding layer facing away from the core and a side wall of each of the plurality of recessed structures is the depth of the recessed structure.

9. The optical fiber mode stripper according to claim 1, wherein the fillers are low-melting-point glass.

10. An optical fiber mode stripper, comprising:
an optical fiber provided with a waveguide destruction region, wherein the waveguide destruction region extends along a length direction of the optical fiber, a portion of the optical fiber which is in the waveguide destruction region comprises a core and a cladding layer, the cladding layer wraps around the core, a plurality of recessed structures are disposed in the cladding layer, the plurality of recessed structures are disposed at intervals along the length direction of the optical fiber and/or a plurality of the recessed structures disposed at intervals circumferentially around the cladding layer; and
fillers filled in the recessed structures, wherein the fillers each have a refractive index greater than a refractive index of the cladding layer.

11. A manufacturing method for the optical fiber mode stripper according to claim 1, comprising:
corroding the optical fiber by an acid corrosion process to form the plurality of recessed structures;
placing the optical fiber in a filler solution, and filling the fillers in the recessed structures; and
removing fillers outside the recessed structures through the acid corrosion process.

12. The manufacturing method for the optical fiber mode stripper according to claim 11, wherein the step of corroding the optical fiber by an acid corrosion process to form the plurality of recessed structures comprises:
removing the coating layer of the optical fiber which is corresponding to the waveguide destruction region at intervals, and forming, in the coating layer, a plurality of grooves exposing the cladding layer at a position where the plurality of grooves are located, wherein the plurality of grooves are arranged at intervals along the length direction of the optical fiber and the plurality of grooves are arranged at intervals circumferentially around the coating layer; and
placing the optical fiber formed with the plurality of grooves in an acid corrosion solution at a certain concentration, and corroding the optical fiber for a period of time to form the plurality of recessed structures at portions of the cladding layer which are opposite to the plurality of grooves.

13. The manufacturing method for an optical fiber mode stripper according to claim 12, wherein the step of placing the optical fiber in a filler solution and filling the fillers in the recessed structures comprises:
placing the optical fiber corroded to form the plurality of recessed structures in a molten filler solution to wholly remove the coating layer of the optical fiber which corresponds to the waveguide destruction region, and filling the fillers in the recessed structures.

14. A laser comprising the optical fiber mode stripper according to claim 1.

15. The laser according to claim 14, wherein depths of the plurality of recessed structures are the same.

16. The laser according to claim 14, wherein depths of the plurality of recessed structures are increased gradually, decreased gradually, or increased gradually first and then decreased gradually along the length direction of the optical fiber,
the depths of ones of the plurality of recessed structures located on a same circumference are the same,
wherein the depths of the plurality of recessed structures are each a maximum distance between a plane in which a side of the cladding layer facing away from the core is located and a side wall of a corresponding one of the plurality of recessed structures.

17. The laser according to claim 14, wherein each of the depths of the plurality of recessed structures is less than one-tenth of a diameter of the cladding layer, wherein a maximum distance between a plane in which a side of the cladding layer facing away from the core and a side wall of each of the plurality of recessed structures is the depth of the recessed structure.

18. The laser according to claim 14, wherein a ratio of an area of each of ones of the plurality of recessed structures on a same section to an area of the cladding layer is less than one half in a direction perpendicular to the length direction of the optical fiber.

19. The laser according to claim 14, wherein each of depths of the plurality of recessed structures is less than 20 μm, wherein a maximum distance between a plane in which a side of the cladding layer facing away from the core and a side wall of each of the plurality of recessed structures is the depth of the recessed structure.

20. The laser according to claim 14, wherein the fillers are low-melting-point glass.
